(19) United States
(12) Patent Application Publication
(10) Pub. No.: US 2026/0077594 A1
(43) Pub. Date: Mar. 19, 2026

(54) LIQUID SUPPLY DEVICE AND INKJET RECORDING DEVICE

(71) Applicant: KYOCERA Document Solutions Inc., Osaka (JP)

(72) Inventors: Yasutaka INUI, Osaka (JP); Shuhei KAWAMATA, Osaka (JP); Masanobu MAESHIMA, Osaka (JP); Takuma ARAKI, Osaka (JP); Yuko YANO, Osaka (JP)

(73) Assignee: KYOCERA Document Solutions Inc., Osaka (JP)

(21) Appl. No.: 19/329,898

(22) Filed: Sep. 16, 2025

(30) Foreign Application Priority Data
Sep. 19, 2024 (JP) 2024-162280

(51) Int. Cl. B41J 2/165; B41J 2/175

(52) U.S. Cl. CPC B41J 2/16526; B41J 2/17563; B41J 2/17596; B41P 2235/31

(57) ABSTRACT

A liquid supply device includes ejection portions which are respectively arranged in a plurality of division flow paths. The ejection portion includes a nozzle, a check valve and a flow path resistant member. The check valve is arranged on the upstream side of the nozzle in the direction of ejection of the liquid and distributes the liquid toward the nozzle when the pressure of the liquid in the division flow path is equal to or greater than a first pressure. The flow path resistant member is arranged between the check valve and the nozzle, generates resistance to the distribution of the liquid and distributes the liquid toward the nozzle when the pressure of the liquid that has passed through the check valve is equal to or greater than a second pressure greater than the first pressure.

### INCORPORATION BY REFERENCE

This application is based upon and claims the benefit of priority from the corresponding Japanese Patent Application No. 2024-162280 (filed on September 19, 2024), the entire contents of which are incorporated herein by reference.

### BACKGROUND

The present disclosure relates to a liquid supply device and an inkjet recording device.

As recording devices such as a printer and a copying machine, inkjet recording devices which discharge an ink on a sheet-shaped recording medium such as paper to record an image are widely used because they can record high-definition images. In such an inkjet recording device, a liquid (an ink or a cleaning liquid) is conveyed by a pump from a container which stores the liquid such as the ink or the cleaning liquid to a recording head which discharges the ink on the recording medium.

### SUMMARY

A liquid supply device according to an aspect of the present disclosure includes a flow path and a pump. A liquid is distributed along the flow path. The pump is connected to the flow path to move the liquid in the flow path. The flow path includes a plurality of division flow paths and ejection portions. The division flow paths are arranged in parallel such that the flow path branches into the division flow paths at a branch portion and the division flow paths merge into one path at a merging portion. The ejection portions are respectively arranged in the division flow paths, and each of the ejection portions ejects the liquid in the corresponding division flow path to an outside. The ejection portion includes a nozzle, a check valve and a flow path resistant member. The nozzle ejects the liquid to the outside. The check valve is arranged on an upstream side of the nozzle in a direction of ejection of the liquid, prevents the liquid from being distributed in a direction opposite to the direction of ejection of the liquid and distributes the liquid in the direction of ejection of the liquid toward the nozzle when a pressure of the liquid in the division flow path is equal to or greater than a first pressure. The flow path resistant member is arranged between the check valve and the nozzle in the direction of ejection of the liquid, generates resistance to the distribution of the liquid and distributes the liquid in the direction of ejection of the liquid toward the nozzle when a pressure of the liquid that has passed through the check valve is equal to or greater than a second pressure greater than the first pressure.

### BRIEF DESCRIPTION OF THE DRAWINGS

FIG. 1 is a schematic cross-sectional front view of an image formation system which includes an inkjet recording device according to an embodiment of the present disclosure;

FIG. 2 is a plan view of an area around a recording unit in the inkjet recording device shown in FIG. 1;

FIG. 3 is a side view of a recording head in the recording unit shown in FIG. 2;

FIG. 4 is a bottom view of the recording head in the recording unit shown in FIG. 2;

FIG. 5 is a front view of a head unit and a maintenance unit in the inkjet recording device shown in FIG. 1;

FIG. 6 is a front view of the head unit and the maintenance unit shown in FIG. 5, and shows a state where the head unit and a liquid supply device have been raised;

FIG. 7 is a front view of the head unit and the maintenance unit shown in FIG. 5, and shows a state where a wipe unit has been moved blow the head unit;

FIG. 8 is a front view of the head unit and the maintenance unit shown in FIG. 5, and shows a state where the head unit has been moved close to the wipe unit;

FIG. 9 is a perspective view of the wipe unit and the liquid supply device shown in FIG. 5;

FIG. 10 is a perspective view of the wipe unit shown in FIG. 9, and shows a state where blade portions have been moved;

FIG. 11 is a perspective view of the blade portion in the wipe unit shown in FIG. 5;

FIG. 12 is a perspective view of a cleaning liquid supply unit in the wipe unit shown in FIG. 5;

FIG. 13 is a side view of the blade portion and the cleaning liquid supply unit in the wipe unit shown in FIG. 5;

FIG. 14 is a perspective view of the cleaning liquid supply unit in the wipe unit shown in FIG. 5 when the cleaning liquid supply unit is viewed from below;

FIG. 15 is a partial cross-sectional perspective view of the wipe unit and the liquid supply device shown in FIG. 9 when they are viewed from below;

FIG. 16 is a partial cross-sectional perspective view of the wipe unit and the liquid supply device shown in FIG. 15, and shows a state where the liquid supply device has been moved close to the wipe unit;

FIG. 17 is an enlarged cross-sectional perspective view of the wipe unit and the liquid supply device shown in FIG. 16;

FIG. 18 is a side view showing a state where the wipe unit shown in FIG. 7 has been moved below the head unit;

FIG. 19 is a side view showing a state where the head unit shown in FIG. 8 has been moved close to the wipe unit;

FIG. 20 is a side view showing a state where a wiping operation has been performed with the wipe unit on the head unit shown in FIG. 19;

FIG. 21 is a piping system diagram of the liquid supply device shown in FIG. 9;

FIG. 22 is a schematic plan view showing a part of piping in the liquid supply device shown in FIG. 21;

FIG. 23 is a vertical cutaway end view of an ejection portion in the liquid supply device shown in FIG. 21; and

FIG. 24 is a partial enlarged cutaway end view of the ejection portion shown in FIG. 23.

### DETAILED DESCRIPTION

An embodiment of the present disclosure will be described below with reference to drawings. The present disclosure is not limited to details described below.

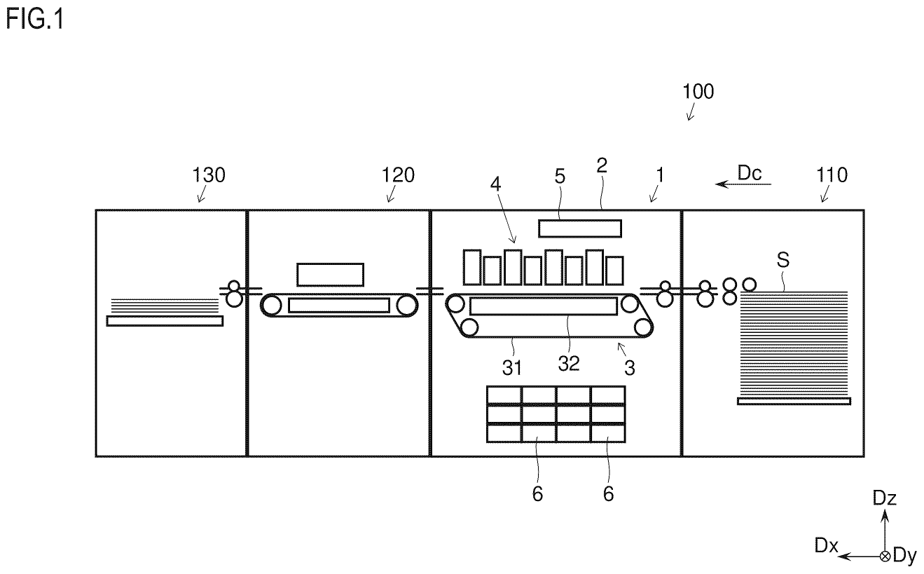

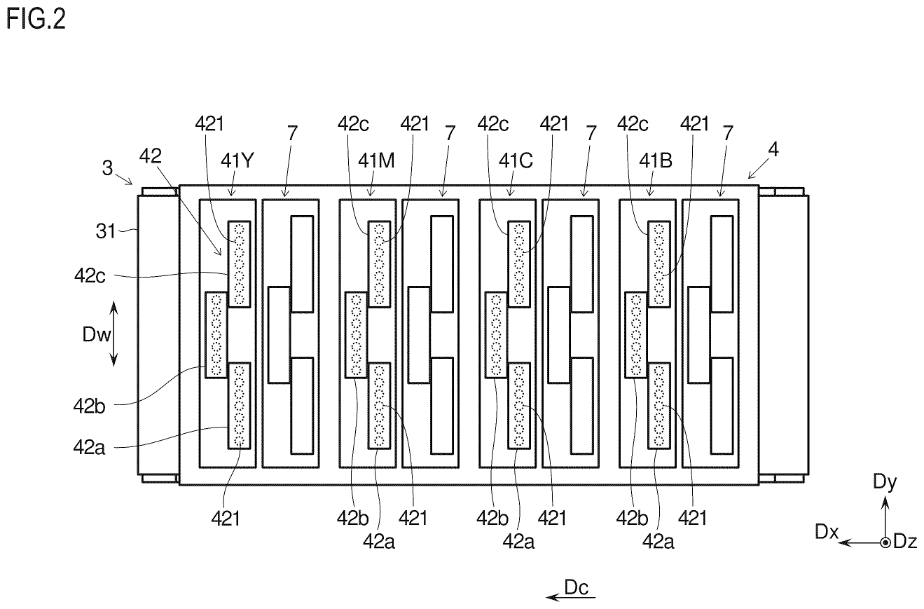

FIG. 1 is a schematic cross-sectional front view of an image formation system 100 which includes an inkjet recording device 1 according to the embodiment. FIG. 2 is a plan view of an area around a recording unit 4 in the inkjet recording device 1 shown in FIG. 1. In the following figures including FIGS. 1 and 2, arrows which indicate the left/right lateral direction Dx, the forward/backward direction Dy and the up/down direction Dz of the device or arrows which indicate a sheet conveyance direction Dc and a sheet width direction Dw are drawn as necessary. The sheet conveyance direction Dc is parallel to the left/right lateral direction Dx of the device, and the sheet width direction Dw is orthogonal to the sheet conveyance direction Dc and is parallel to the forward/backward direction Dy of the device.

The image formation system 100 includes a sheet supply device 110, the inkjet recording device 1, a drying device 120 and a sheet ejection device 130. In the image formation system 100, the sheet supply device 110, the inkjet recording device 1, the drying device 120 and the sheet ejection device 130 are coupled in this order sequentially from a most upstream portion of the image formation system 100 in the sheet conveyance direction Dc.

The sheet supply device 110 stores a plurality of sheets (recording media) S, and separates and supplies the sheets S to the inkjet recording device 1 one by one. The inkjet recording device 1 records (forms) an image with an inkjet system on the sheet S conveyed from the sheet supply device 110. The drying device 120 performs heating on the sheet S in which the ink image has been recorded by the inkjet recording device 1, and thereby dries the ink. The sheet ejection device 130 ejects the sheet S in which the recording (printing) of the image has been completed by drying the ink in the drying device 120 to a removable tray or the like. The sheet ejection device 130 may include a post-processing device which performs post-processing such as punching, stapling and folding on the sheets S after the recording.

The inkjet recording device 1 is, for example, an inkjet recording-type image forming apparatus. As shown in FIGS. 1 and 2, the inkjet recording device 1 includes a conveyance unit 3, the recording unit 4 and a control unit 5 inside a device main body 2.

The conveyance unit 3 is arranged below the recording unit 4 to be opposite the recording unit 4. The conveyance unit 3 passes the sheet S received from the sheet supply device 110 below the recording unit 4, and conveys the sheet S toward the drying device 120. The conveyance unit 3 includes a seamless conveyance belt 31 and an suction unit 32.

The conveyance belt 31 includes a plurality of through holes (not shown) which penetrate from a front side to a back side. The suction unit 32 is arranged inside the seamless conveyance belt 31 and is adjacent to the inner circumferential surface of the conveyance belt 31 in an upper portion. In the upper surface of the suction unit 32, a plurality of suction holes (not shown) which suck air downward are formed. The conveyance unit 3 sucks and holds the sheet S to the upper surface of the conveyance belt 31 with the suction unit 32, and conveys the sheet S.

The recording unit 4 is arranged above the conveyance unit 3 to be opposite the conveyance unit 3. The recording unit 4 is opposite the sheet S which is sucked and held to the upper surface of the conveyance belt 31 and is conveyed, and is arranged above the conveyance belt 31 with a predetermined distance provided therebetween.

As shown in FIG. 2, the recording unit 4 holds head units 41B, 41C, 41M and 41Y which correspond to four colors of black, cyan, magenta and yellow, respectively. The head units 41B, 41C, 41M and 41Y are arranged side by side along the sheet conveyance direction Dc such that the longitudinal direction is parallel to the sheet width direction Dw. The recording unit 4 is connected to an ink container 6 which is arranged below the recording unit 4 and stores inks for the four colors of black, cyan, magenta and yellow to be supplied to the recording unit 4. Since the four head units 41B, 41C, 41M and 41Y basically have the same configuration, in the following description, unless otherwise limited, identification symbols “B”, “C”, “M” and “Y” indicating the colors may be omitted.

Each of the head units 41 for the colors includes a line-type inkjet recording head 42. In each of the head units 41 for the colors, a plurality of recording heads 42 (for example, three (42a, 42b and 42c)) are arranged in a staggered configuration along the sheet width direction Dw.

The recording heads 42 include a plurality of ink discharge nozzles 421 in bottom portions thereof. The ink discharge nozzles 421 are arranged side by side along the sheet width direction Dw, and can discharge the ink over the entire recording region on the sheet S. The recording unit 4 sequentially discharges the inks from the recording heads 42 of the head units 41B, 41C, 41M and 41Y for the four colors toward the sheet S conveyed by the conveyance belt 31, and thereby records a full-color image or a monochrome image on the sheet S.

The control unit 5 includes a CPU, a storage unit and other electronic circuits and electronic components (all of which are not shown). The CPU controls, based on control programs and data stored in the storage unit, the operations of constituent elements provided in the inkjet recording device 1, and thereby executes processing related to the functions of the inkjet recording device 1. The conveyance unit 3 and the recording unit 4 each individually receive commands from the control unit 5 to perform recording on the sheet S in conjunction with each other. For the entire image formation system 100, the control unit 5 may individually transmit commands to the sheet supply device 110, the drying device 120 and the sheet ejection device 130 to perform recording on the sheet S in conjunction with each other. The storage unit is formed with, for example, a combination of non-volatile storage devices such as a program ROM (Read Only Memory) and a data ROM and volatile storage devices such as a RAM (Random Access Memory).

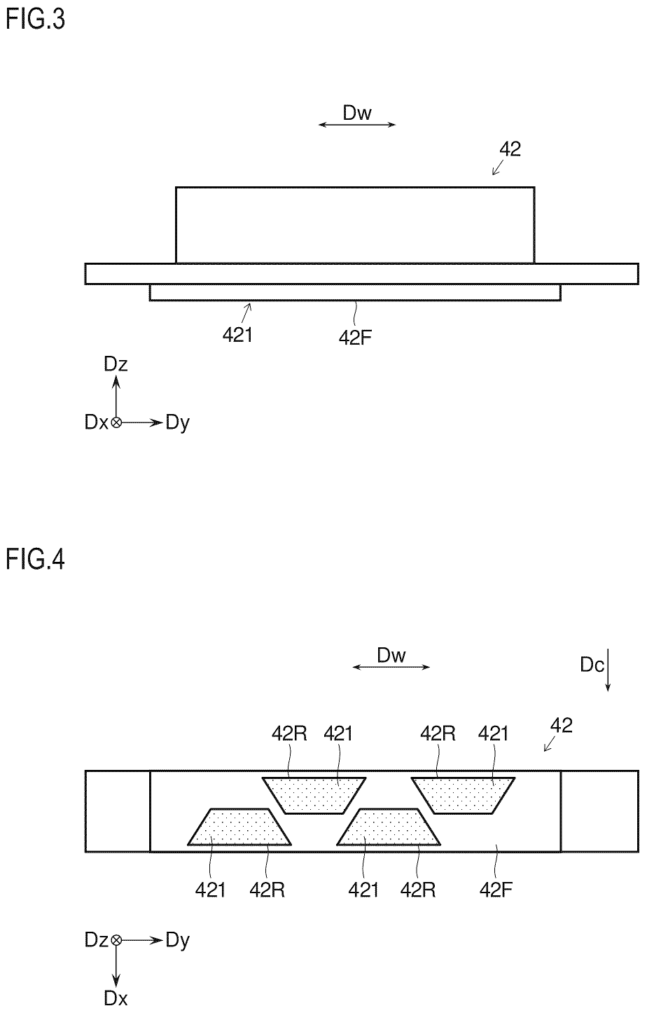

Then, the configuration of the recording head 42 in the recording unit 4 will be described. FIGS. 3 and 4 are respectively a side view and a bottom view of the recording head 42 in the recording unit 4 shown in FIG. 2. Since the recording heads 42a, 42b and 42c for the three colors have the same shape and the same configuration, the identification symbols (a, b, c) are omitted in the following description.

The recording head 42 includes an ink discharge surface 42F in its bottom surface. The ink discharge surface 42F is opposite the surface (upper surface) of the sheet S conveyed on the conveyance belt 31. As shown in FIG. 4, the ink discharge surface 42F includes nozzle regions 42R where a large number of ink discharge nozzles 421 are arranged. In other words, in the ink discharge surface 42F, a large number of ink discharge nozzles 421 are open, and thus the ink is discharged on the sheet S. In the ink discharge surface 42F, a water-repellent film (not shown) is formed. The inks of the four colors stored in the ink container 6 (see FIG. 1) are individually supplied to the recording heads 42 of the four colors (black, cyan, magenta and yellow).

The recording head 42 discharges, based on a control signal from the control unit 5, the ink from the ink discharge nozzles 421 toward the sheet S sucked and held on the conveyance surface of the conveyance belt 31 and conveyed according to image data received from an external computer. Specifically, the control unit 5 inputs a discharge drive signal in which a predetermined drive voltage and a predetermined pulse width are set to the recording head 42 to drive the recording head 42, and thereby discharges the ink from the ink discharge nozzles 421. In this way, on the sheet S on the conveyance belt 31, a color image in which the inks of the four colors of black, cyan, magenta and yellow are superimposed or a monochrome image is formed.

As shown in FIG. 1, the inkjet recording device 1 includes maintenance units 7. The maintenance units 7 are individually arranged side by side on an upstream side in the sheet conveyance direction Dc for the head units 41 of the four colors (black, cyan, magenta and yellow). Since the four maintenance units 7 basically have the same configuration, a typical one will be described below.

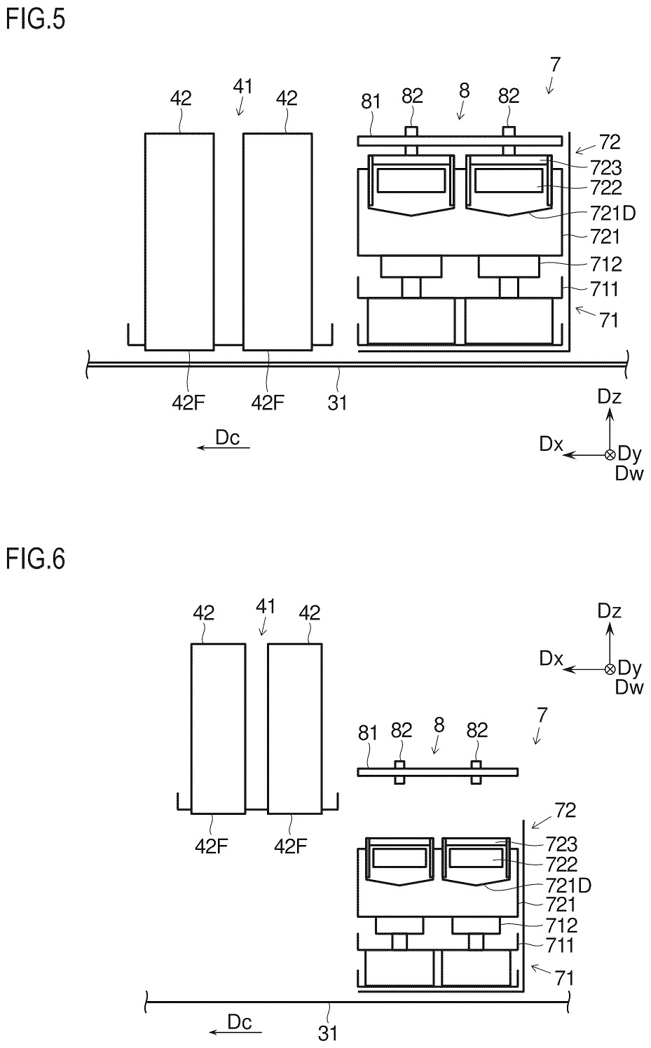

FIG. 5 is a front view of the head unit 41 and the maintenance unit 7 in the inkjet recording device 1 shown in FIG. 1. The maintenance unit 7 includes a cap unit 71, a wipe unit 72 and a liquid supply device 8. When as shown in FIG. 5, maintenance processing is not performed on the recording head 42, the cap unit 71, the wipe unit 72 and the liquid supply device 8 are arranged to be stacked in this order from below in the up/down direction Dz.

The cap unit 71 includes a frame member 711 and cap portions 712. The frame member 711 is formed in the shape of a flat plate extending horizontally in the sheet conveyance direction Dc (left/right lateral direction Dx) and the sheet width direction Dw (forward/backward direction Dy), and is rectangular in plan view. The cap portion 712 is formed in the shape of a recess which is recessed downward, and is arranged on the upper surface of the frame member 711. As with a plurality of recording heads 42 arranged side by side, a plurality of (for example, three) cap portions 712 are arranged in a staggered configuration along the sheet width direction Dw.

The cap portions 712 are removable with respect to the ink discharge surfaces 42F, and cover the ink discharge surfaces 42F. When the cap unit 71 is arranged in a maintenance position in which the cap unit 71 covers the ink discharge surfaces 42F during the maintenance processing on the recording heads 42, the bottom portions of the recording heads 42 enter the interiors of the cap portions 712. In this way, closed spaces are formed between the ink discharge surfaces 42F and the cap portions 712.

The wipe unit 72 includes a waste liquid tray 721, blade portions 722, cleaning liquid supply units 723. The waste liquid tray 721 is formed in the shape of a rectangular parallelepiped extending horizontally in the sheet conveyance direction Dc (left/right lateral direction Dx) and the sheet width direction Dw (forward/backward direction Dy), and is rectangular in plan view. The waste liquid tray 721 includes recess portions 721D which are formed in its upper surface and are recessed downward. As with a plurality of recording heads 42 arranged side by side, a plurality of (for example, three) recess portions 721D are arranged in a staggered configuration along the sheet width direction Dw.

The blade portion 722 and the cleaning liquid supply unit 723 are provided in each of the three recess portions 721D. During the maintenance processing on the recording heads 42, the wipe unit 72 is arranged below the ink discharge surfaces 42F. The blade portions 722 carry, to the ink discharge surfaces 42F, the cleaning liquid supplied from the liquid supply device 8 to the cleaning liquid supply units 723. Then, the blade portions 722 wipe off the ink discharged to the ink discharge surfaces 42F together with the cleaning liquid carried to the ink discharge surfaces 42F (wiping operation).

The liquid supply device 8 includes a support plate 81 and ejection portions 82. The support plate 81 is formed in the shape of a flat plate extending horizontally in the sheet conveyance direction Dc (left/right lateral direction Dx) and the sheet width direction Dw (forward/backward direction Dy), and is rectangular in plan view. The ejection portions 82 are supported by the support plate 81 to penetrate the support plate 81 in the up/down direction Dz (thick direction). As with a plurality of recording heads 42 arranged side by side, a plurality of (for example, three) ejection portions 82 are arranged in a staggered configuration along the sheet width direction Dw.

Specifically, the ejection portions 82 are arranged above the cleaning liquid supply units 723 in the wipe unit 72. During the maintenance processing on the recording heads 42, the support plate 81 approaches the wipe unit 72 in the up/down direction Dz, and supplies the cleaning liquid from the ejection portions 82 toward the cleaning liquid supply units 723.

The recording unit 4 includes a raising and lowering mechanism and a sliding mechanism (both of which are not shown). The raising and lowering mechanism and the sliding mechanism include a motor, a guide rail, a gear group, a wire (belt), a pulley and the like. The head unit 41 and the liquid supply device 8 are supported by the raising and lowering mechanism to be movable in the up/down direction Dz. The cap unit 71 is supported by the sliding mechanism to be movable in the sheet conveyance direction Dc (left/right lateral direction Dx). The wipe unit 72 is supported by the raising and lowering mechanism and the sliding mechanism to be movable in the up/down direction Dz and the sheet conveyance direction Dc (left/right lateral direction Dx).

FIG. 5 shows a state where the head unit 41 (recording heads 42) is arranged in a recording position for the sheet S on the conveyance belt 31, and the maintenance unit 7 is arranged in a retracted position separated from the head unit 41 in the sheet conveyance direction Dc (left/right lateral direction Dx) with the raising and lowering mechanism and the sliding mechanism. The head unit 41 (recording heads 42) has been moved downward to approach the conveyance belt 31. The liquid supply device 8 has been moved downward to approach the wipe unit 72, and is arranged in a supply position for the cleaning liquid to the wipe unit 72.

The inkjet recording device 1 performs the maintenance processing on the recording head 42 at a predetermined timing. The maintenance processing on the recording head 42 is performed, for example, when recording is started after a long stop or between recording operations. When the maintenance processing on the recording head 42 is performed, the control unit 5 moves the constituent elements of the maintenance unit 7 below the head unit 41 with the raising and lowering mechanism and the sliding mechanism.

FIG. 6 is a front view of the head unit 41 and the maintenance unit 7 shown in FIG. 5, and shows a state where the head unit 41 and the liquid supply device 8 have been raised. When the maintenance processing on the recording head 42 is performed, the liquid supply device 8 is raised from the supply position and is arranged in a retracted position separated from the wipe unit 72. When the maintenance processing on the recording head 42 is performed, the head unit 41 is temporarily raised from the recording position and is arranged in a retracted position separated from the conveyance belt 31.

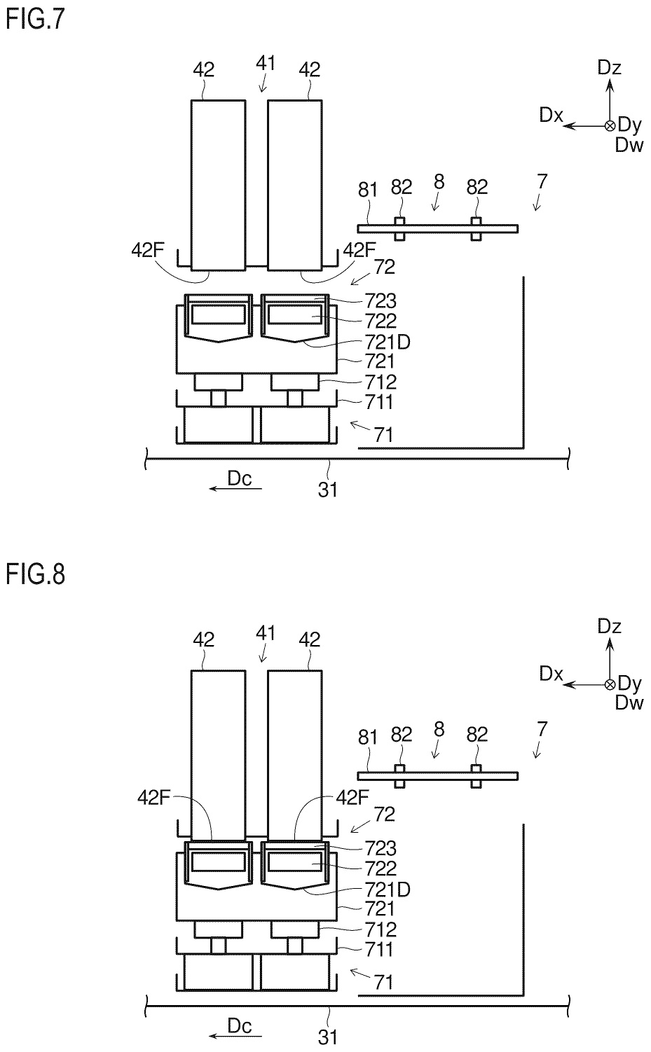

FIG. 7 is a front view of the head unit 41 and the maintenance unit 7 shown in FIG. 5, and shows a state where the wipe unit 72 has been moved blow the head unit 41. When the maintenance processing on the recording head 42 is performed, the head unit 41 is arranged in the retracted position, and then the wipe unit 72 and the cap unit 71 are moved to the downstream side in the sheet conveyance direction Dc to approach the head unit 41 and are arranged in the maintenance position. The wipe unit 72 and the cap unit 71 have entered a space below the head unit 41 arranged in the retracted position.

FIG. 8 is a front view of the head unit 41 and the maintenance unit 7 shown in FIG. 5, and shows a state where the head unit 41 has been moved close to the wipe unit 72. When the maintenance processing on the recording head 42 is performed, the wipe unit 72 and the cap unit 71 are arranged in the maintenance position, and then the head unit 41 (see FIGS. 6 and 7) temporarily arranged in the retracted position is moved downward and is arranged in the maintenance position where the head unit 41 is close to the wipe unit 72. In the maintenance position, the wipe unit 72 is arranged opposite the ink discharge surfaces 42F of the head unit 41 (recording heads 42).

Although a procedure is not shown, the procedure can be adopted in which when the maintenance processing on the recording head 42 is performed, the wipe unit 72 is arranged in the retracted position (see FIGS. 5 and 6), only the cap unit 71 is arranged in the maintenance position (see FIGS. 7 and 8) and then the head unit 41 temporarily arranged in the retracted position is moved downward and is arranged in the maintenance position where the head unit 41 is close to the cap unit 71. In the maintenance position, the cap unit 71 is fitted to the ink discharge surfaces 42F of the head unit 41 (recording heads 42), and the bottom portions of the recording heads 42 enter the interiors of the cap portions 712.

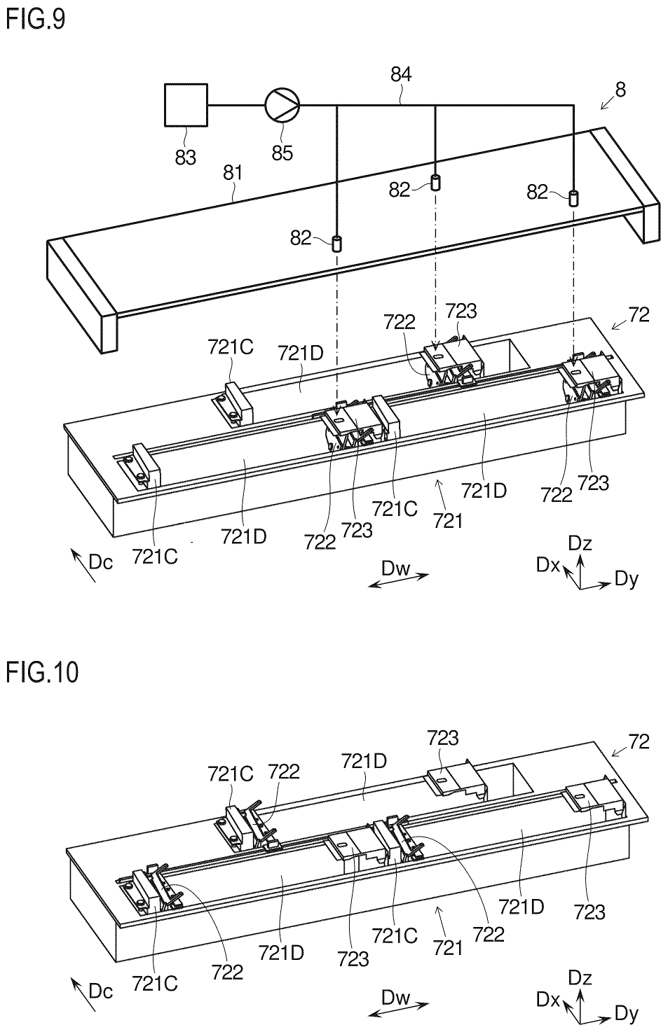

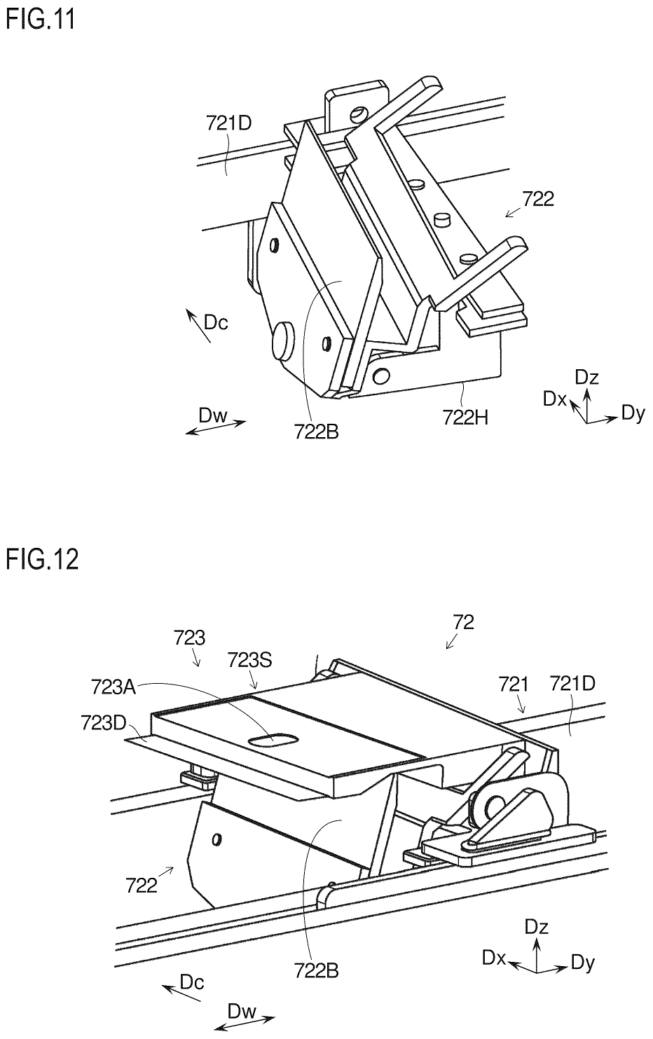

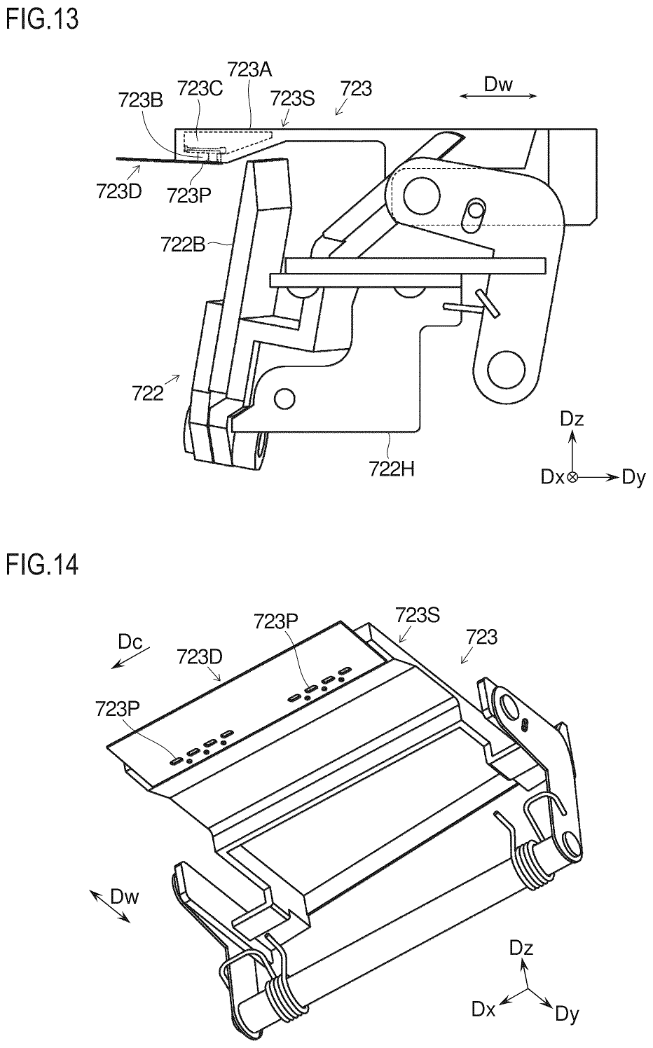

Then, the configuration of the wipe unit 72 will be described. FIG. 9 is a perspective view of the wipe unit 72 and the liquid supply device 8 shown in FIG. 5. FIG. 10 is a perspective view of the wipe unit 72 shown in FIG. 9, and shows a state where the blade portions 722 have been moved. FIG. 11 is a perspective view of the blade portion 722 in the wipe unit 72 shown in FIG. 5. FIG. 12 is a perspective view of the cleaning liquid supply unit 723 in the wipe unit 72 shown in FIG. 5. FIG. 13 is a side view of the blade portion 722 and the cleaning liquid supply unit 723 in the wipe unit 72 shown in FIG. 5. FIG. 14 is a perspective view of the cleaning liquid supply unit 723 in the wipe unit 72 shown in FIG. 5 when the cleaning liquid supply unit 723 is viewed from below. As shown in FIGS. 9 and 10, the wipe unit 72 includes the waste liquid tray 721, the blade portions 722 and the cleaning liquid supply units 723.

In each of the recess portions 721D arranged in a staggered configuration along the sheet width direction Dw in the waste liquid tray 721, the blade portion 722 and the cleaning liquid supply unit 723 are provided. The recess portion 721D is formed in the shape of a rectangle extending long in the sheet width direction Dw when viewed in plan view. The length of the recess portion 721D in the sheet conveyance direction Dc and the length of the recess portion 721D in the sheet width direction Dw are longer than the length of the ink discharge surface 42F. The ink and the cleaning liquid wiped off from the ink discharge surface 42F fall into the recess portion 721D.

In the recess portion 721D, a liquid receiving portion 721C is provided. The liquid receiving portion 721C is arranged on the side of an end (front side in the forward/backward direction Dy) of the recess portion 721D in the sheet width direction Dw and in the completion position of the wiping operation of the blade portion 722 (see FIGS. 9 and 10). The liquid receiving portion 721C is formed in the shape of a box member which has an upper surface, a front surface and left and right side surfaces and in which a back surface and a lower surface are open. In other words, the liquid receiving portion 721C is in the shape of the box member in which the side of the start position of the wiping operation of the blade portion 722 and the lower surface are open. The liquid receiving portion 721C receives the ink and the cleaning liquid wiped off from the ink discharge surface 42F.

The support plate 81 of the liquid supply device 8 is arranged above the waste liquid tray 721 (see FIG. 9). The ejection portions 82 provided in the support plate 81 are arranged in a staggered configuration along the sheet width direction Dw, and are located above the cleaning liquid supply units 723.

As shown in FIG. 11, the blade portion 722 includes a holder 722H and a blade 722B. The holder 722H is supported by the sliding mechanism (not shown) which is provided in an upper portion of the waste liquid tray 721, extends in the sheet width direction Dw and is movable in the sheet width direction Dw in the recess portion 721D (see FIGS. 9 and 10). For the wiping operation on the ink discharge surface 42F performed by the blade portions 722, FIG. 9 shows a state where the blade portions 722 are arranged in the start position, and FIG. 10 shows a state where the blade portions 722 are arranged in the completion position.

The blade 722B is held by the holder 722H, and a cutting edge protrudes upward. The blade 722B is made of, for example, rubber such as EPDM (Ethylene Propylene Diene Rubber), and is an elastic member in which the cutting edge extending substantially in the sheet conveyance direction Dc is provided at an upper end. When in the maintenance position, the head unit 41 is moved downward to approach the wipe unit 72, the blade 722B makes contact with the ink discharge surface 42F from below at a predetermined pressure. Then, the blade 722B is moved along the sheet width direction Dw as the holder 722H holding the blade 722B is moved.

The cleaning liquid supply unit 723 is arranged on the side of the other end (back side in the forward/backward direction Dy) of the recess portion 721D in the sheet width direction Dw and in the start position of the wiping operation of the blade portion 722 (see FIGS. 9 and 10). As shown in FIG. 12, in a state where the blade portion 722 is arranged in the start position of the wiping operation, the cleaning liquid supply unit 723 is arranged on an upper side with respect to the blade portion 722. As shown in FIGS. 12 to 14, the cleaning liquid supply unit 723 includes a supply member 723S and a delivery member 723D.

The supply member 723S is formed in the shape of a rectangular parallelepiped extending in the sheet conveyance direction Dc and the sheet width direction Dw, and is rectangular in plan view. The upper surface of the supply member 723S is flat. The supply member 723S includes a storage portion 723C. The storage portion 723C is arranged at an end portion of the supply member 723S on the side of the completion position (front side in the forward/backward direction Dy) of the wiping operation of the blade portion 722.

The storage portion 723C has a hollow structure which includes an internal space for storing the cleaning liquid. The storage portion 723C includes an inlet 723A which opens upward and an outlet 723B which opens downward.

The inlet 723A is arranged opposite the ejection portion 82 of the liquid supply device 8 arranged in the supply position for the cleaning liquid to the wipe unit 72 in the up/down direction Dz (see FIG. 9). As shown in FIG. 13, in a state where the blade portion 722 is arranged in the start position of the wiping operation, the outlet 723B is located on the side of the completion position (front side in the forward/backward direction Dy) of the wiping operation with respect to the blade portion 722. The cleaning liquid supplied from the liquid supply device 8 to the cleaning liquid supply unit 723 is stored in the storage portion 723C via the inlet 723A, and is ejected to the outside of the storage portion 723C via the outlet 723B.

The delivery member 723D is joined to the lower surface of the storage portion 723C of the supply member 723S. The delivery member 723D is, for example, a sheet member which is formed of synthetic resin or the like, is rectangular in plan view and is flexible. As shown in FIGS. 12 and 13, a tip end portion (front end portion in the forward/backward direction Dy) of the delivery member 723D in the sheet width direction Dw protrudes forward beyond a front end portion of the supply member 723S (storage portion 723C).

As shown in FIG. 14, the delivery member 723D includes through holes 723P which penetrate in the up/down direction Dz. The through holes 723P are arranged opposite the outlet 723B of the storage portion 723C in the up/down direction Dz (see FIG. 13).

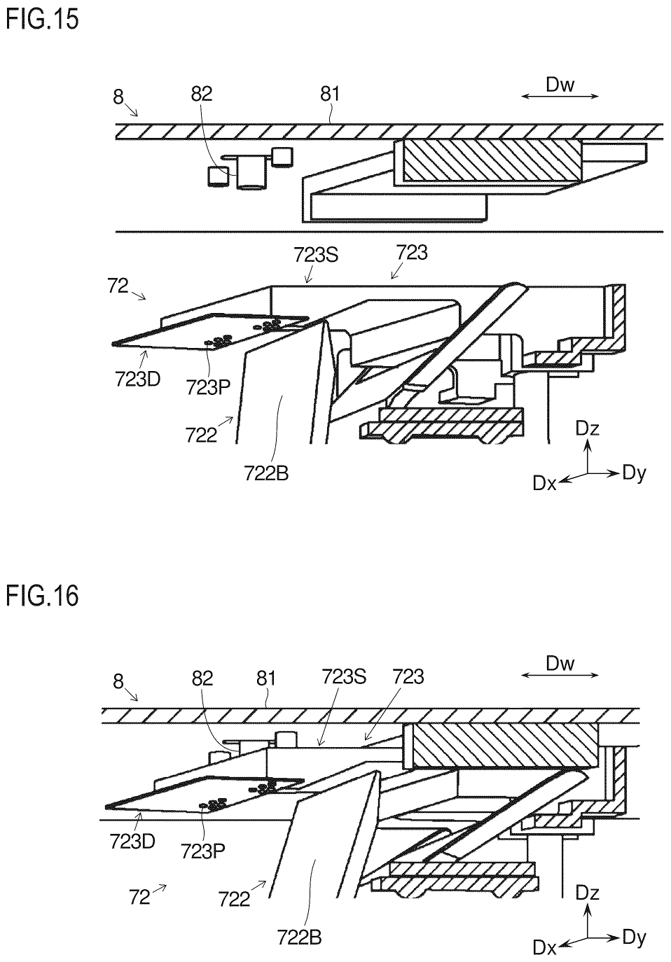

FIG. 15 is a partial cross-sectional perspective view of the wipe unit 72 and the liquid supply device 8 shown in FIG. 9 when they are viewed from below. When the cleaning liquid is not supplied to the wipe unit 72, as shown in FIG. 15, the liquid supply device 8 is moved upward from the supply position and is arranged in the retracted position separated from the wipe unit 72.

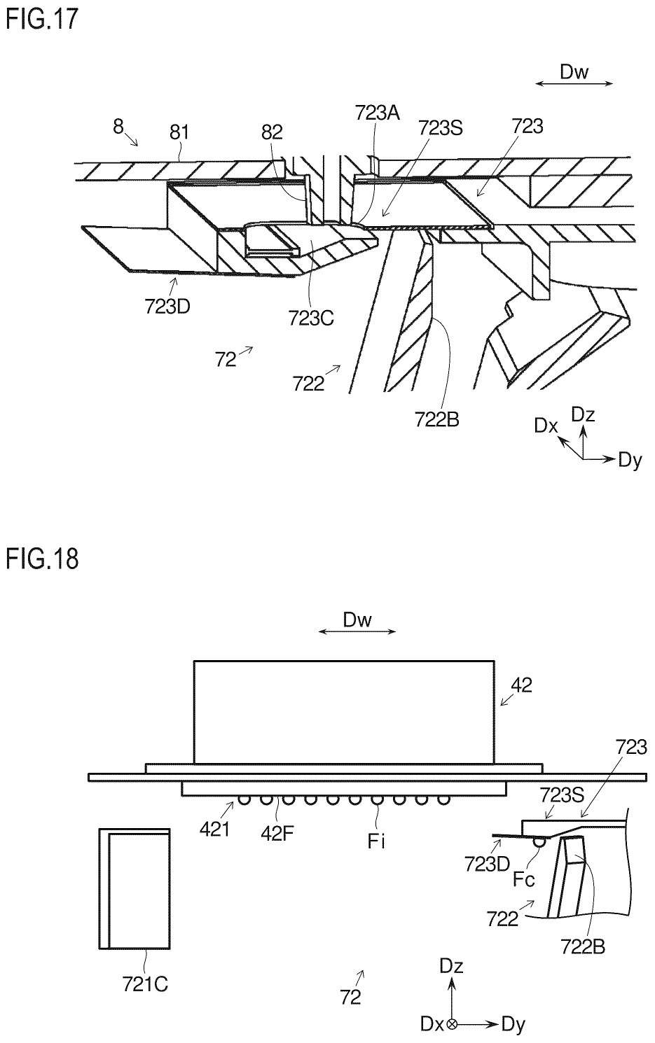

FIG. 16 is a partial cross-sectional perspective view of the wipe unit 72 and the liquid supply device 8 shown in FIG. 15, and shows a state where the liquid supply device 8 has been moved close to the wipe unit 72. FIG. 17 is an enlarged cross-sectional perspective view of the wipe unit 72 and the liquid supply device 8 shown in FIG. 16. When the cleaning liquid is supplied to the wipe unit 72, as shown in FIGS. 16 and 17, the liquid supply device 8 is moved downward from the retracted position and is arranged in the supply position for the cleaning liquid in which the liquid supply device 8 is close to the wipe unit 72. The inlet 723A of the cleaning liquid supply unit 723 of the wipe unit 72 is arranged opposite the ejection portion 82 of the liquid supply device 8 in the up/down direction Dz, and the cleaning liquid flows from the liquid supply device 8.

Then, the wiping operation performed by the wipe unit 72 on the ink discharge surfaces 42F will be described. FIG. 18 is a side view showing a state where the wipe unit 72 shown in FIG. 7 has been moved below the head unit 41. When the wiping operation is performed on the ink discharge surfaces 42F in the maintenance processing on the recording head 42, the wipe unit 72 is moved to the maintenance position and is arranged opposite the ink discharge surfaces 42F of the head unit 41 (recording heads 42).

Before this stage, in the wipe unit 72, the supply of the cleaning liquid from the liquid supply device 8 has been completed. The cleaning liquid Fc flows out to the lower surface of the cleaning liquid supply unit 723 from the through holes 723P of the delivery member 723D. The cleaning liquid Fc is held by surface tension on the lower side of the cleaning liquid supply unit 723 in a state where the cleaning liquid Fc spreads over a predetermined length in the sheet width direction Dw and over the entire region of the lower surface of the cleaning liquid supply unit 723 in the sheet conveyance direction Dc.

Furthermore, the ink Fi is discharged to the ink discharge surface 42F from the ink discharge nozzles 421. The ink Fi includes, for example, the ink of high viscosity in the ink discharge nozzles 421, a foreign substance, air bubbles and the like, and is forcibly pushed out from the ink discharge nozzles 421. The ink Fi is held by surface tension on the lower side of the ink discharge surface 42F in a state where the ink Fi spreads over a predetermined length in the sheet width direction Dw and over the entire region of the ink discharge surface 42F in the sheet conveyance direction Dc.

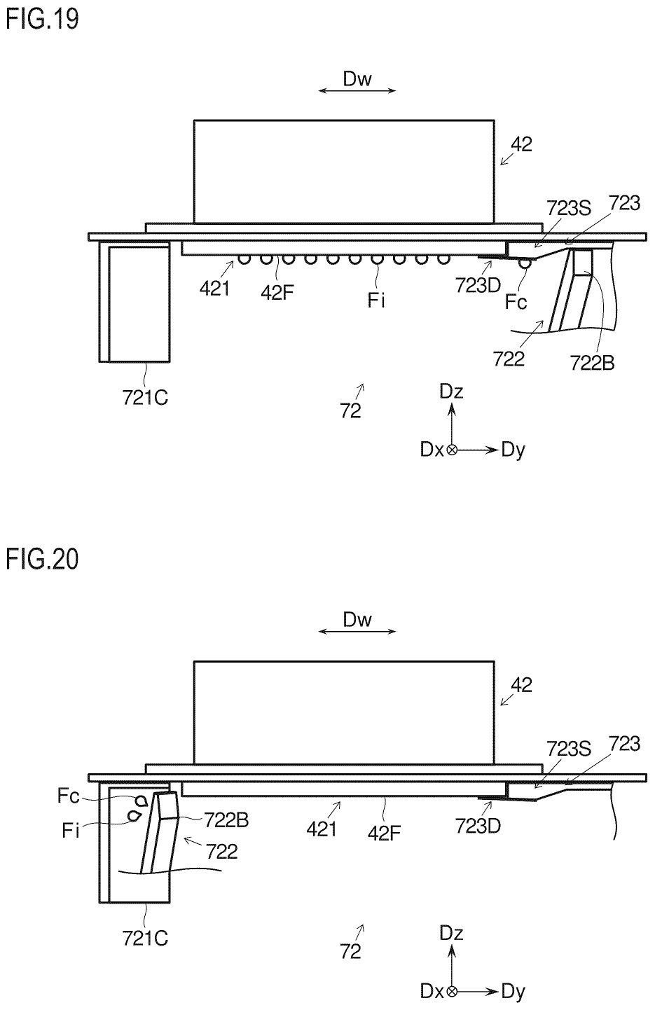

Then, the head unit 41 is moved downward to approach the wipe unit 72. FIG. 19 is a side view showing a state where the head unit 41 shown in FIG. 8 has been moved close to the wipe unit 72. As shown in FIG. 19, the blade 722B of the wipe unit 72 makes contact with the lower surface of the cleaning liquid supply unit 723 from below at a predetermined pressure. Thereafter, the blade 722B wipes off the cleaning liquid Fc on the lower surface of the cleaning liquid supply unit 723, and further carries the cleaning liquid Fc to the ink discharge surface 42F. The cleaning liquid Fc is carried by the blade 722B to the ink discharge surface 42F, is mixed with the ink Fi held on the ink discharge surface 42F and is wiped off.

FIG. 20 is a side view showing a state where the wiping operation has been performed with the wipe unit 72 on the head unit 41 shown in FIG. 19. As shown in FIG. 20, when the blade 722B (the blade portion 722) reaches a downstream end (front side in the forward/backward direction Dy) of the ink discharge surface 42F in the direction of movement of the blade 722B, the movement of the blade 722B is stopped. Thereafter, the blade 722B (the blade portion 722) is moved downward to separate from the ink discharge surface 42F. The ink Fi and the cleaning liquid Fc wiped off from the ink discharge surface 42F with the blade 722B are received by the liquid receiving portion 721C, fall into the recess portions 721D and are collected.

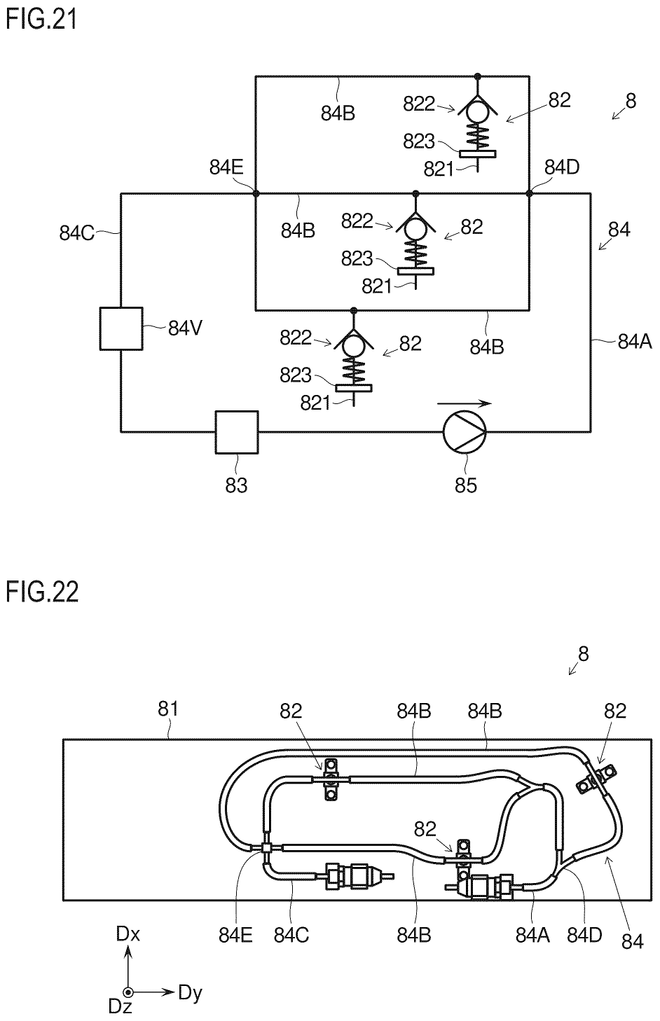

Then, the configuration of the liquid supply device 8 will be described. FIG. 21 is a piping system diagram of the liquid supply device 8 shown in FIG. 9. FIG. 22 is a schematic plan view showing a part of piping in the liquid supply device 8 shown in FIG. 21. The liquid supply device 8 includes, in addition to the support plate 81 and the ejection portions 82, a tank 83, a flow path 84 and a pump 85.

The tank 83 stores the cleaning liquid. The flow path 84 is connected to the tank 83. The pump 85 is driven to supply the cleaning liquid from the tank 83 to the flow path 84, and the cleaning liquid flows around the flow path 84 and is collected by the tank 83.

The flow path 84 is attached to the support plate 81. The cleaning liquid (liquid) is distributed along the flow path 84. The flow path 84 is formed annularly as a whole from the outlet to the inlet of the tank 83. The flow path 84 is formed with three sections of a supply flow path 84A, a plurality of division flow paths 84B and a collection flow path 84C sequentially from an upstream side in this order in the direction of distribution of the cleaning liquid.

The supply flow path 84A is connected to the downstream side of the tank 83, and the cleaning liquid flows from the tank 83 into the supply flow path 84A. The collection flow path 84C is connected to the upstream side of the tank 83, and the cleaning liquid flows out toward the tank 83. The division flow paths 84B are arranged in parallel such that the supply flow path 84A branches into the division flow paths 84B at a branch portion 84D and the division flow paths 84B merge into one collection flow path 84C at a merging portion 84E. The number of division flow paths 84B is equal to the number (for example, three) of cleaning liquid supply units 723 included in the wipe unit 72.

The pump 85 is connected to the flow path 84. The pump 85 is located on the downstream side of the tank 83 in the direction of distribution of the cleaning liquid, and is arranged in the supply flow path 84A. The pump 85 pressurizes the cleaning liquid in the flow path 84 to move the cleaning liquid in the flow path 84.

The ejection portion 82 is arranged in each of the three division flow paths 84B. As described previously, the ejection portion 82 is held by the support plate 81 to penetrate the support plate 81 in the up/down direction Dz (thickness direction). The ejection portion 82 ejects the cleaning liquid in the division flow path 84B to the outside. In other words, the ejection portion 82 supplies the cleaning liquid in the division flow path 84B to the cleaning liquid supply unit 723 in the wipe unit 72.

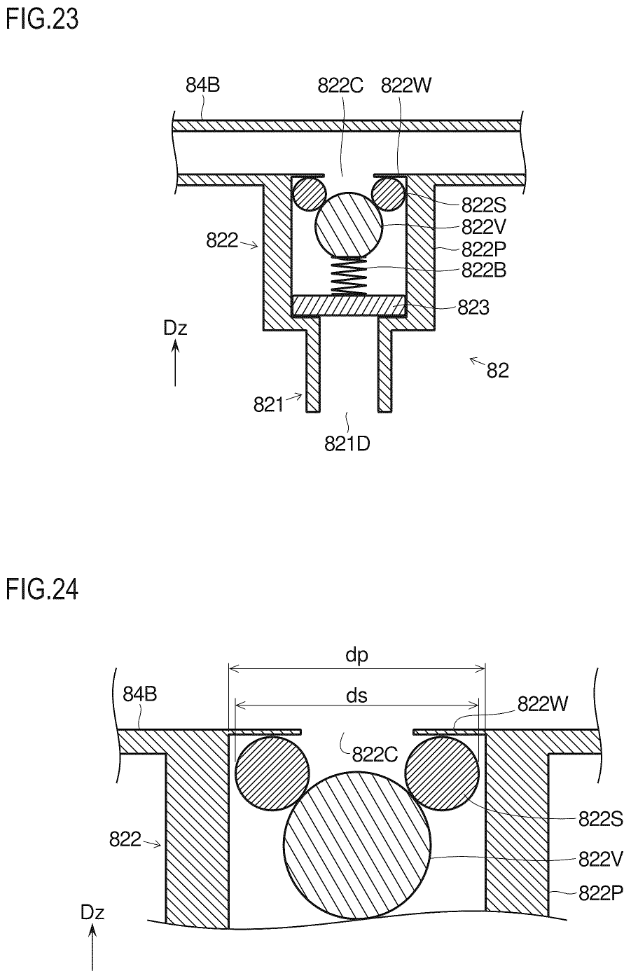

Then, the detailed configuration of the ejection portion 82 will be described. FIG. 23. FIG. 23 is a vertical cutaway end view of the ejection portion 82 in the liquid supply device 8 shown in FIG. 21. The ejection portion 82 is formed in the shape of a cylinder extending in the up/down direction. The ejection portion 82 includes a nozzle 821, a check valve 822 and a flow path resistant member 823.

The nozzle 821 is arranged at a lower end of the ejection portion 82. The nozzle 821 is formed in the shape of a cylinder extending in the up/down direction, and is connected to the check valve 822 at an upper end portion, and a lower end portion of the nozzle 821 is open as an ejection port 821D. The nozzle 821 ejects the cleaning liquid from the ejection port 821D at the lower end portion to the outside.

The check valve 822 is connected to the division flow path 84B via a communication portion 822C. The check valve 822 is arranged on the upstream side of the nozzle 821 in the direction of ejection of the cleaning liquid (downward direction in FIG. 23). The check valve 822 is a ball-type check valve in which a valve member is formed with a ball 822V. The check valve 822 includes a biasing member 822B which biases the ball 822V toward the communication portion 822C on the upstream side in the direction of ejection.

The check valve 822 prevents the cleaning liquid from being distributed in a direction (upward direction in FIG. 23) opposite to the direction of ejection of the cleaning liquid in the communication portion 822C due to the ball 822V serving as the valve member. On the other hand, in the check valve 822, the ball 822V is separated from the communication portion 822C against the biasing force of the biasing member 822B when the pressure of the cleaning liquid in the division flow path 84B is equal to or greater than a first pressure. In other words, the check valve 822 distributes the cleaning liquid toward the nozzle 821 in the direction of ejection when the pressure of the cleaning liquid in the division flow path 84B is equal to or greater than the first pressure.

The flow path resistant member 823 is arranged between the check valve 822 and the nozzle 821 in the direction of ejection of the cleaning liquid (downward direction in FIG. 23). The flow path resistant member 823 has the same shape as a cross section of the cylindrical ejection portion 82 in a direction intersecting the direction of ejection of the cleaning liquid, and is formed in the shape of a circle when viewed in the direction of ejection. The flow path resistant member 823 covers the cross section of the ejection portion 82 through which the cleaning liquid is distributed.

The flow path resistant member 823 generates resistance to the distribution of the cleaning liquid. Then, the flow path resistant member 823 distributes the cleaning liquid toward the nozzle 821 in the direction of ejection when the pressure of the cleaning liquid which has passed through the check valve 822 is equal to or greater than a second pressure greater than the first pressure.

In the configuration described above, even if a difference in performance occurs among a plurality of check valves 822, the cleaning liquid stays on the upstream side of the flow path resistant member 823 until the pressure of the cleaning liquid on the upstream side of the flow path resistant member 823 is equal to or greater than the second pressure. Then, when the pressure of the cleaning liquid on the upstream side of the flow path resistant member 823 is equal to or greater than the second pressure, the cleaning liquid is ejected from the nozzles 821 in the ejection portions 82 at the same time. Hence, when the cleaning liquid is pressurized by the pump 85 to be ejected from a plurality of nozzles 821, the cleaning liquid can be ejected uniformly.

The flow path 84 includes an on-off valve 84V. The on-off valve 84V is arranged in the collection flow path 84C on the downstream side of the merging portion 84E in the direction of ejection of the cleaning liquid. The on-off valve 84V opens and closes the flow path 84. In other words, when the on-off valve 84V is opened, the cleaning liquid in the flow path 84 is distributed whereas when the on-off valve 84V is closed, the cleaning liquid in the flow path 84 is prevented from being distributed.

In the configuration described above, the on-off valve 84V is closed, and thus it is possible to easily increase the pressure of the cleaning liquid in the division flow paths 84B and in the ejection portions 82 to the first pressure or the second pressure. Hence, the opening and closing of the on-off valve 84V is controlled, and thus it is possible to supply an uniform amount of cleaning liquid to each of the three cleaning liquid supply units 723 in the wipe unit 72 at an appropriate timing.

In a case where the pressure of the cleaning liquid distributed in the division flow paths 84B when the on-off valve 84V is in an open state is assumed to be a third pressure, the third pressure is lower than the second pressure. In other words, the pressure of the cleaning liquid distributed in the division flow paths 84B when the on-off valve 84V is in an open state is lower than pressure of the cleaning liquid which can pass through the flow path resistant member 823.

Furthermore, in a case where the pressure of the cleaning liquid distributed in the division flow paths 84B when the on-off valve 84V is in an open state is assumed to be the third pressure, the third pressure is lower than the first pressure. In other words, the pressure of the cleaning liquid distributed in the division flow paths 84B when the on-off valve 84V is in an open state is lower than pressure of the cleaning liquid which can pass through the check valve 822.

In the configuration described above, when the on-off valve 84V is in an open state, it is possible to prevent the cleaning liquid from being ejected from the ejection portions 82. Then, the opening and closing of the on-off valve 84V is switched as necessary, and thus the cleaning liquid can be ejected from the ejection portions 82 at an appropriate timing.

The flow path resistant member 823 is a filter for the cleaning liquid. The filter is formed with, for example, a metal mesh. In this configuration, it is possible to remove impurities from the cleaning liquid and to adjust the pressure of the cleaning liquid ejected from the ejection portion 82.

Then, the detailed configuration of the check valve 822 will be described. FIG. 24 is a partial enlarged cutaway end view of the ejection portion shown in FIG. 23. The check valve 822 includes, in addition to the ball 822V and the biasing member 822B, a cylindrical portion 822P and a sealing member 822S.

The cylindrical portion 822P extends in the direction of ejection of the cleaning liquid (up/down direction in FIGS. 23 and 24). The cylindrical portion 822P is connected to the division flow path 84B in the communication portion 822C located at an upstream end in the direction of ejection of the cleaning liquid. A downstream end of the cylindrical portion 822P in the direction of ejection is connected to the nozzle 821.

The cylindrical portion 822P contains the ball 822V, the biasing member 822B and the flow path resistant member 823. In the cylindrical portion 822P, the ball 822V, the biasing member 822B and the flow path resistant member 823 are arranged in this order from the upstream side in the direction of ejection of the cleaning liquid. The biasing member 822B biases the ball 822V toward the communication portion 822C on the upstream side in the direction of ejection. The flow path resistant member 823 is arranged immediately above the nozzle 821.

The sealing member 822S is arranged in the cylindrical portion 822P. Specifically, the sealing member 822S is arranged between a wall portion 822W of an upstream end of the cylindrical portion 822P and the ball 822V on the upstream side of the ball 822V in the direction of ejection of the cleaning liquid. The sealing member 822S is, for example, an annular member, such as an O-ring, which is formed with an elastic member such as rubber, and an outer circumferential portion is in intimate contact with the wall portion 822W of the cylindrical portion 822P. The outside diameter of the sealing member 822S is larger than the inside diameter of the communication portion 822C which is formed in the shape of a circle when viewed in plan view. The inside diameter of the sealing member 822S is smaller than the outside diameter of the ball 822V.

The ball 822V is movable in the direction of ejection of the cleaning liquid (up/down direction in FIGS. 23 and 24) in the cylindrical portion 822P. When ball 822V is moved to the upstream side in the direction of ejection, the ball 822V makes contact with the inner circumferential portion of the sealing member 822S to close the check valve 822. In this way, the check valve 822 distributes the cleaning liquid from the nozzle 821 only in the direction of ejection of the cleaning liquid, and thus the backflow of the cleaning liquid is prevented.

The biasing member 822B is arranged on the downstream side (the side of the nozzle 821) in the direction of ejection with respect to the ball 822V. The biasing member 822B is formed with, for example, a compression coil spring, and a coil portion axis line extends along the center axis line of the cylindrical portion 822P.

An end portion of the biasing member 822B on the upstream side in the direction of ejection is in contact with the ball 822V serving as the valve member. An end portion of the biasing member 822B on the downstream side in the direction of ejection is in contact with the flow path resistant member 823. In this way, the biasing member 822B biases the ball 822V in a direction in which the ball 822V makes contact with the annular sealing member 822S toward the upstream side in the direction of ejection of the cleaning liquid. The check valve 822 causes, with the biasing member 822B, the ball 822V to make contact with the inner circumferential portion of the annular sealing member 822S to distribute the cleaning liquid from the nozzle 821 only in the direction of ejection of the cleaning liquid, and thereby prevents the backflow of the cleaning liquid.

Then, as shown in FIG. 24, the outside diameter ds of the sealing member 822S is smaller than the inside diameter dp of the cylindrical portion 822P. Here, for example, in a case where the outside diameter ds of the sealing member 822S is equal to or larger than the inside diameter dp of the cylindrical portion 822P, when the sealing member 822S is adhered to the ball 822V due to the drying of the ink or the like, even if the pressure of the cleaning liquid in the division flow path 84B is equal to or greater than the first pressure, the distribution of the cleaning liquid in the check valve 822 in the direction of ejection may be prevented by the sealing member 822S.

However, in the configuration of the embodiment described above, since the outside diameter ds of the sealing member 822S is smaller than the inside diameter dp of the cylindrical portion 822P, even if the sealing member 822S is adhered to the ball 822V due to the drying of the ink or the like, a gap is generated between the outer circumferential portion of the sealing member 822S and the inner circumferential portion of the cylindrical portion 822P. Hence, when the pressure of the cleaning liquid in the division flow path 84B is equal to or greater than the first pressure, the check valve 822 can distribute the cleaning liquid in the direction of ejection toward the nozzle 821.

Although the embodiment of the present disclosure has been described above, the scope of the present disclosure is not limited to the embodiment.

For example, although in the embodiment described above, the liquid which is ejected from the ejection portions 82 by the liquid supply device 8 and is supplied to the other members is the cleaning liquid, the liquid is not limited to the cleaning liquid. The liquid supplied by the liquid supply device 8 may be another liquid such as an ink.

What is claimed is:

1. A liquid supply device comprising:
a flow path along which a liquid is distributed; and
a pump that is connected to the flow path to move the liquid in the flow path,
wherein the flow path includes:
a plurality of division flow paths that are arranged in parallel such that the flow path branches into the division flow paths at a branch portion and the division flow paths merge into one path at a merging portion; and
ejection portions which are respectively arranged in the division flow paths, and each of which ejects the liquid in the corresponding division flow path to an outside, and
the ejection portion includes:
a nozzle that ejects the liquid to the outside;
a check valve that
is arranged on an upstream side of the nozzle in a direction of ejection of the liquid,
prevents the liquid from being distributed in a direction opposite to the direction of ejection of the liquid and
distributes the liquid in the direction of ejection of the liquid toward the nozzle when a pressure of the liquid in the division flow path is equal to or greater than a first pressure; and
a flow path resistant member that
is arranged between the check valve and the nozzle in the direction of ejection of the liquid,
generates resistance to the distribution of the liquid and
distributes the liquid in the direction of ejection of the liquid toward the nozzle when a pressure of the liquid that has passed through the check valve is equal to or greater than a second pressure greater than the first pressure.

2. The liquid supply device according to claim 1,
wherein the flow path includes an on-off valve that is arranged on a downstream side of the merging portion in a direction of distribution of the liquid to open and close the flow path.

3. The liquid supply device according to claim 2,
wherein a third pressure that is a pressure of the liquid distributed in the division flow path when the on-off valve is in an open state is lower than the second pressure.

4. The liquid supply device according to claim 2,
wherein a third pressure that is a pressure of the liquid distributed in the division flow path when the on-off valve is in an open state is lower than the first pressure.

5. The liquid supply device according to claim 1,
wherein the flow path resistant member is a filter for the liquid.

6. The liquid supply device according to claim 1,
wherein the check valve is a ball-type check valve that includes:
a ball that serves as a valve member;
a cylindrical portion that extends in the direction of ejection of the liquid and contains the ball;
a biasing member that is arranged in the cylindrical portion to bias the ball toward the upstream side in the direction of ejection of the liquid; and
an annular sealing member that
is arranged on the upstream side of the ball in the direction of ejection of the liquid between a wall portion of an upstream end of the cylindrical portion and the ball, and
has an inside diameter smaller than the ball, and
an outside diameter of the sealing member is smaller than an inside diameter of the cylindrical portion.

7. An inkjet recording device comprising:
a recording head that includes an ink discharge surface to which an ink discharge nozzle for discharging an ink on a recording medium is open; and
the liquid supply device according to claim 1 that supplies a cleaning liquid to the ink discharge surface.
